(19) United States
(12) Patent Application Publication
(10) Pub. No.: US 2010/0077357 A1
(43) Pub. Date: Mar. 25, 2010

(54) ELECTRONIC APPARATUS WITH QUICK RESPONSE TIME AND METHOD THEREOF

(75) Inventors: XIAO-GUANG LI, Shenzhen City (CN); MING-FENG TSAI, Tu-Cheng (TW); KUAN-HONG HSIEH, Tu-Cheng (TW); HAN-CHE WANG, Tu-Cheng (TW); CHENG-HAO CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/417,608

(22) Filed: Apr. 2, 2009

(30) Foreign Application Priority Data
Sep. 25, 2008 (CN) 200810304653.3

(51) Int. Cl. G06F 3/048

(52) U.S. Cl. 715/838

(57) ABSTRACT

A method of an electronic apparatus with quick response time capable of switching between an original image mode and a thumbnail image mode is provided. The method includes: providing a plurality of original images and a plurality of thumbnail images associated with the original images; receiving an instruction from a user input; determining whether the instruction is a thumbnail image input; switching the electronic apparatus to the thumbnail image mode if the user input is a thumbnail image input and the electronic apparatus is in the original image mode; and displaying the thumbnail image associated with the currently displayed original image. A related electronic apparatus is also provided.

### BACKGROUND

1. Technical Field

The disclosure relates to an electronic apparatus with quick response time and a method thereof.

2. Description of Related Art

Nowadays, many electronic apparatuses, e.g., mobile phones, digital photo frames, electronic readers (e-readers), are capable of storing and displaying electronic documents (e.g., digital images, digital texts, etc). Due to size, cost, and power constraints, processors of these electronic apparatuses are not powerful enough to respond quickly to user commands especially when a user wants to manipulate a digital image with high resolution.

Therefore, it is necessary to provide an electronic apparatus and a method to overcome the above-identified deficiency.

### BRIEF DESCRIPTION OF THE DRAWINGS

The components of the drawings are not necessarily drawn to scale, the emphasis instead being placed upon clearly illustrating the principles of an electronic apparatus with quick response time and method thereof. Moreover, in the drawings, like reference numerals designate corresponding parts throughout several views.

FIG. 1 is a block diagram of an electronic apparatus with quick response time in accordance with an exemplary embodiment.

FIG. 2 is a flowchart illustrating a method for providing quick response time applied to the electronic apparatus of FIG. 1 in accordance with an exemplary embodiment.

### DETAILED DESCRIPTION

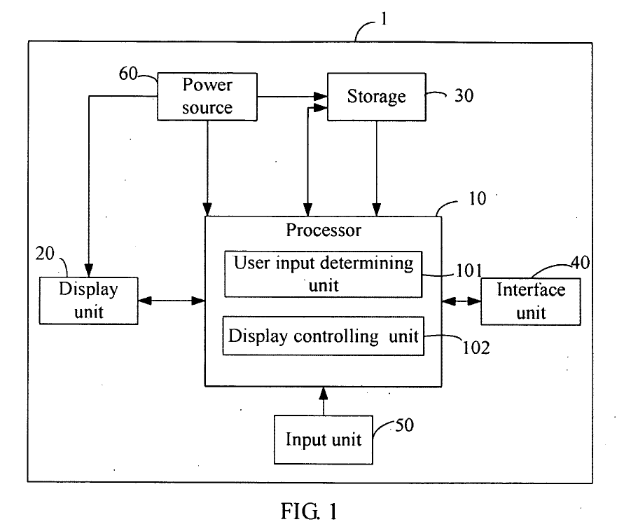

FIG. 1 is a block diagram of an electronic apparatus 1 with quick response time in accordance with an exemplary embodiment.

The electronic apparatus 1 at least includes a processor 10, a display unit 20, a storage 30, an interface unit 40, an input unit 50, and a power source 60. The electronic apparatus 1 can be an e-reader, a mobile phone, or a digital photo frame, etc.

The power source 60 is configured for providing power to elements of the electronic apparatus 1, such as the processor 10 and the display unit 20.

The interface unit 40 is configured for connecting to an external apparatus (not shown). The external apparatus can be a storage card (e.g., a secure digital (SD) card, a compact flash (CF) card), or another electronic apparatus (e.g., a digital camera, a mobile phone, or a computer).

The input unit 50 is configured for generating instructions in response to user input. The input unit 50 can include input keys, a touch pad, or the like. In the exemplary embodiment, the input unit 50 may be a keyboard that includes a previous button (not shown) configured for generating a previous instruction to have a previous image displayed and a next button (not shown) configured for generating a next instruction to have a next image displayed, in response to user input. Or alternatively, the input unit 50 is a touch pad. A sliding touch from right to left on the touch pad is defined as the previous instruction, and a sliding touch from left to right on the touch pad is defined as the next instruction.

The storage 30 is configured for storing a plurality of original images and thumbnail images associated with the original images. In the exemplary embodiment, the thumbnail images can be generated on command by the thumbnail generator.

The electronic apparatus 1 can switch between an original image mode for browsing the original images and a thumbnail image mode for browsing the thumbnail images. Because the size of the thumbnail images are smaller than that of the original images, the electronic apparatus 1 can respond to display commands for the thumbnail images at a higher speed than when responding to display commands for the original images. Therefore, in the thumbnail image mode, the electronic apparatus 1 can display thumbnail images with quick response time, and users can find their desired images quickly. This will be described in detail below.

The processor 10 includes a user input determining unit 101 and a display controlling unit 102.

The user input determining unit 101 is configured for receiving the instructions generated by the input unit 50 and determining whether the user input is a thumbnail image input.

In the exemplary embodiment, in the original image mode, if the user input determining unit 101 determines the user input is a thumbnail image input, the display controlling unit 102 switches the electronic apparatus 1 to the thumbnail image mode, and displays the thumbnail image associated with the currently displayed original image on the display unit 20. In the thumbnail image mode, if the user input determining unit 101 determines the subsequent input is a thumbnail image input, the display controlling unit 102 displays a previous or next thumbnail image on the display unit 20 according to the thumbnail image input. If the user input determining unit 101 determines the subsequent user input is not a thumbnail image input, or, if the user input determining unit 101 dose not receive an instruction from the input unit 50 for a first predetermined time interval, the display controlling unit 102 switches the electronic apparatus 1 to the original image mode, and displays the original image corresponding the currently displayed thumbnail image on the display unit 20.

In this embodiment, if a duration of the user input is longer than a second predetermined time interval, the user input is a thumbnail image input. For example, if the previous button or the next button is held down or contacting with the touch pad from right to left or from left to right is maintained at end of input stroke longer than the second predetermined time interval, the user input is a thumbnail image input. Or alternatively, if a time interval between user inputs is less than a third predetermined time interval, the user input is a thumbnail image input. For example, if the user presses the previous or next button twice in quick succession, or the user touches the touch pad from right to left or from left to right twice in quick succession, the user input is a thumbnail image input.

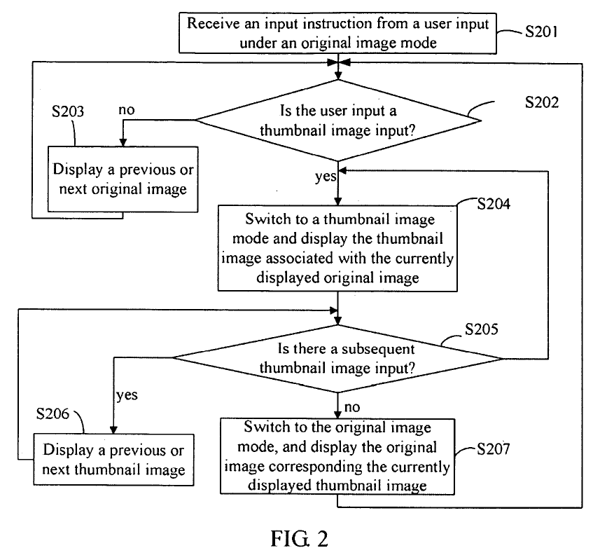

FIG. 2 is a flowchart illustrating a method for providing quick response time applied to the electronic apparatus 1 in accordance with an exemplary embodiment.

In step S201, in the original image mode, the user input determining unit 101 receives an instruction generated by the input unit 50.

In step S202, the user input determining unit 101 determines whether the user input is a thumbnail image input according to the instruction. If yes, the process goes to step S204, if no, the process goes to step S203.

In step S203, the display controlling unit 102 displays a previous or next original image, and the process goes to step S202.

In step S204, the display controlling unit 102 switches the electronic apparatus 1 to the thumbnail image mode, and displays the thumbnail image associated with the currently displayed image.

In step S205, the user input determining unit 101 determines whether the subsequent user input is a thumbnail image input, or determines whether an instruction from the input unit 50 is not received for the first predetermined time interval. If the subsequent user input is not a thumbnail image input, or if the user input determining unit 101 does not receive an instruction from the user input 50 for the first predetermined time interval, the process goes to step S207, if no, the process goes to step S206.

In step S206, the display controlling unit 102 displays a previous or next thumbnail image in the thumbnail image mode, and the process goes to step S205.

In step S207, the display controlling unit 102 switches the electronic apparatus 1 to the original image mode, and displays the original image corresponding the currently displayed thumbnail image, and the process goes to step S202.

Although the present disclosure has been specifically described on the basis of preferred embodiments, the disclosure is not to be construed as being limited thereto. Various changes or modifications may be made to the embodiments without departing from the scope and spirit of the disclosure.

What is claimed is:

1. An electronic apparatus with quick response time capable of switching between an original image mode for browsing original images and a thumbnail image mode for browsing thumbnail images, the electronic apparatus comprising:
a memory configured for storing a plurality of original images and a plurality of thumbnail images associated with the original images;
an input unit configured for generating an instruction in response to user input;
a processor comprising:
a user input determining unit configured for receiving the instruction from the input unit, and determining whether the user input is a thumbnail image input for browsing the thumbnail images according to the instruction; and
a display controlling unit configured for switching the electronic apparatus from the original image mode to the thumbnail image mode if the user input determining unit determines that the user input is a thumbnail image input and the electronic apparatus is in the original image mode, and displaying the thumbnail image associated with the currently displayed original image;
wherein in the thumbnail image mode, if the user input determining unit determines that the subsequent user input is the thumbnail image input, the display controlling unit displays a previous or next thumbnail image according to the thumbnail image input.

2. The electronic apparatus as described in claim 1, wherein the user input determining unit is configured for determining that the user input is a thumbnail image input if a duration of the user input is greater than a first predetermined time interval.

3. The electronic apparatus as described in claim 1, wherein the user input determining unit is configured for determining that the user input is a thumbnail image input if a time interval between user inputs is less than a second predetermined time interval.

4. The electronic apparatus as described in claim 1, wherein the display controlling unit is further configured for switching the electronic apparatus to the original image mode and displaying the original image corresponding the currently displayed thumbnail image if the user input determining unit does not receive an instruction from the input unit for a third predetermined time interval in the thumbnail image mode.

5. A method of an electronic apparatus with quick response time capable of switching between an original image mode and an thumbnail image mode, the method comprising:
providing a plurality of original images and a plurality of thumbnail images associated with the original images;
receiving an instruction from a user input;
determining whether the instruction is a thumbnail image input for browsing thumbnail images;
switching the electronic apparatus from the original image mode to the thumbnail image mode if the user input is the thumbnail image input and the electronic apparatus is original image mode; and
displaying the thumbnail image associated with the currently displayed original image;
wherein in the thumbnail image mode, if the subsequent user input is a thumbnail image input, the electronic apparatus displays a previous or next thumbnail image according to the thumbnail image input.

6. The method as described in claim 5, wherein the step of determining whether the instruction is a thumbnail image input comprising:
determining that the user input is the thumbnail image input if a duration of the user input is greater than a first predetermined time interval.

7. The method as described in claim 5, wherein the step of determining whether the instruction is a thumbnail image input comprising:
determining that the user input is the thumbnail image input if a time interval between user inputs is less than a second predetermined time interval.

8. The method as described in claim 5, further comprising:
switching the electronic apparatus to the original image mode, and displaying the original image corresponding the currently displayed thumbnail image if no instruction is received for a third predetermined time interval in the thumbnail image mode.
